(19) United States
(12) Patent Application Publication
(10) Pub. No.: US 2004/0070198 A1
(43) Pub. Date: Apr. 15, 2004

(54) Connection piece for fluid lines and device embedded thereas

(76) Inventor: Harald Rohrig, Spiesen-Elversberg (DE)

Correspondence Address: Charles R Hoffmann, Hoffmann & Baron, 6900 Jericho Turnpike, Syosset, NY, 11791, US

(21) Appl. No.: 10/467,531

(22) PCT Filed: Dec. 3, 2002
(86) PCT No.: PCT/EP02/13637

(30) Foreign Application Priority Data
Dec. 20, 2001 (DE) 101 62 657.6

(51) Int. Cl. F16L 35/00

(52) U.S. Cl. 285/39; 285/340

(57) ABSTRACT

A union for which may be secured by press fitting in a housing recess (6). It possesses an insert (12) which comprises holding means (17) having at least one sleeve-like insert body (15) and holding means (17) serving for holding a fluid line to be connected. For fixing the the insert (12) a separate attachment ring (28) is provided, which may be press fitted in the housing recess (6) and which in the press fitted state is in front of at least one support face (32) on the insert (12), said support face facing in a direction opposite to the direction (13) of insertion.

The invention relates to a union for fluid power lines designed for press fitting in a housing recess, comprising an insert adapted to be inserted into the housing recess, such insert including at least one sleeve-like insert body and holding means, fixed on such insert body, serving to hold the fluid line to be attached, such insert being designed to be secured in the housing recess by press fitting. The invention furthermore relates to fluid power equipment fitted with such a union.

Such a union is for example disclosed in the European patent publication 0 723 103 B1. It is employed to connect fluid lines with fluid power equipment such as valves or drives. The union is press fitted in the respective housing recess of the fluid power equipment so that no screw connection means are required and compact dimensions are possible. In the case of the said European patent publication 0 723 103 B1 the union comprises an insert to be inserted into the housing recess and having a sleeve-like insert body, on which holding means are fixed serving for holding the fluid line to be connected. The press fitting operation provides for direct pressing in place of the insert body in the housing recess, the outer periphery of the insert body having spur-like anchoring means which are engaged with the wall of the housing recess.

The assembly by press fitting does admittedly offer advantages from the point of view manufacturing technology, but there are difficulties if the equipment having to be provided with a union has different housing materials. In the case of synthetic resin housings the anchoring means of the insert body should project as far as possible in order to bite deep into the material. In connection with metal housings the anchoring means should on the contrary project less, since otherwise there would be the danger of their being shorn off on pressing into the housing recess. Therefore the configuration of the anchoring means is normally the result of a compromise or it is necessary for different types of unions to be available, in the case of which the insert bodies are respectively individually designed on a case to case basis. The first alternative may lead to functional problems whereas the second alternative necessitates relatively high manufacturing complexity and high costs.

Therefore the German patent publication 20,020,052.6 (utility model) has already made a proposal to design the anchoring means of an insert body for anchoring in synthetic resin material and for anchoring a plastic ring in the housing recess, prior to press fitting the insert body, in the course of fitting metal housing.

This is however something requiring different manufacturing operations when producing housing recesses in plastic housings on the one hand and metal housings on the other hand, something which leads to disadvantages as regards the course of manufacture.

Accordingly one object of the present invention is to provide a union, which may be anchored in a housing recess irrespectively the consistency of the material of the housing wall in a simple and reliable manner. Furthermore, a fluid power means provided with at least one such a union is to be proposed.

In order to achieve this object in the case of a union of the type initially mentioned there is the provision that for securing the insert placed in the housing recess a separate attachment ring is provided which is in front of at least one support face of the insert in a direction opposite to the direction of insertion, such ring being adapted for being press fitted in the housing recess.

The object is furthermore attained by a fluid power means designed in the form of a valve or drive for example, which possesses at least one housing recess, in which such a union is anchored.

Accordingly there is a functional separation between the holding of a fluid line to be connected and anchoring of the union to the housing. The anchoring is still performed by a press fitting operation, but without however relating to the insert body designed as a single assembly with the holding means, but to an additionally provided, separate attachment ring. This attachment ring may be press fitted in the housing recess, it fixing the insert, which is placed in the housing recess, in its proper position. The attachment ring may be designed in the form of a comparatively simple structure, which as regards the configuration relevant for the press fit joint is matched to suit the wall material of the housing recess so that different attachment rings may be employed dependent on the housing material in order to fix one and the same standardized type of insert. Those components of the union, which have a relatively complex design and whose production involves expensive tools, may accordingly be manufactured in a standard form so that only the components responsible for anchoring have to the customized, something which owing to simple design possible results in a considerable saving in costs.

Further advantageous developments of the invention are defined in the dependent claims.

The attachment ring is preferably sleeve-like in form. It is possible then to have a relatively large depth of pressing and accordingly a reliable press connection more particularly in those cases in which the housing recess has an extremely small cross section.

Compact longitudinal dimensions of the union are favored if the attachment ring surrounds the insert body from the front side facing opposite to the direction of insertion along at least part of its length in a cuff-like fashion. In this case it is possible for the attachment ring to be seated on a receiving section of reduced diameter of the outer periphery which is stepped in the longitudinal direction, of the insert body.

The attachment ring is best adapted to be plugged on the insert body. There is the possibility of assembling the attachment ring with the insert body even prior to insertion in the housing recess to constitute a subassembly so that after this insertion of the insert and the press fitting of the attachment ring may take place in one and the same working step. In this connection it is advantageous for the attachment ring to be held by locking in position on the insert body.

In order to be able to fit fluid power equipment with unions of the type of the invention in a rational manner it is possible on the one hand for identically designed inserts to be employed and on the other hand to use attachment rings having a different design of the means relevant for press fitting, the attachment rings being selected more especially in accordance with the material properties of the housing of the fluid power equipment to be fitted therewith and being combined with the inserts.

In order to prevent damage to the insert body on press fitting the attachment ring the attachment ring may be provided with abutment means, which limit the depth of press fitting into position. These abutment means may for example be constituted by an abutment collar projecting radially to the outside.

The holding means serving for holding an inserted fluid power line preferably consist of a holding ring consisting preferably entirely of resiliently elastic material, such holding ring being retained at its outer edge on the insert body and having radially inwardly projecting resiliently elastic, flexible retaining projections, which are in a position of acting on the outer periphery of an inserted fluid power line with a retaining action.

In order to release the holding connection an annularly designed release element is preferably provided, which fits into the insert body and may be actuated manually from the outside in order to release the holding means and more especially the arresting projections from engagement with the fluid power line.

The insert body preferably consists of two insert body parts connected permanently together by welding or by some other suitable joining operation. The holding means are preferably held between these insert body parts and more particularly by an annular groove.

It is convenient for the insert to also comprise a sealing ring attached to the insert body. The sealing ring preferably has a double function and serves for sealing cooperation with the outer periphery of the inserted fluid power line and the wall of the housing recess.

In the following the invention will be explained with reference to the accompanying drawings.

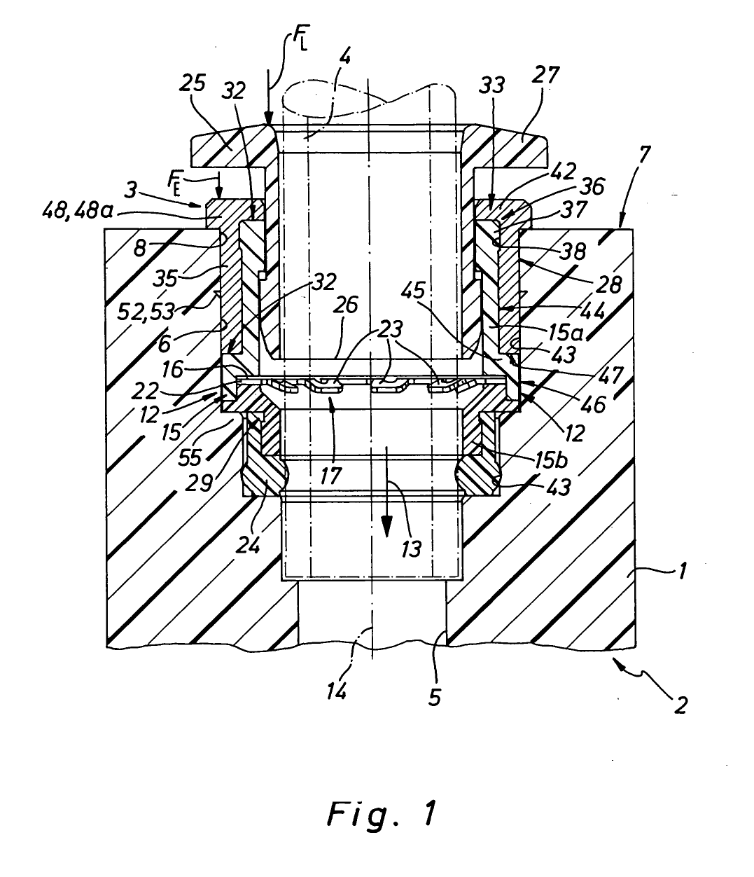

FIG. 1 shows a portion of a fluid power device, which is fitted with a preferred form of the union in accordance with the invention, in longitudinal section.

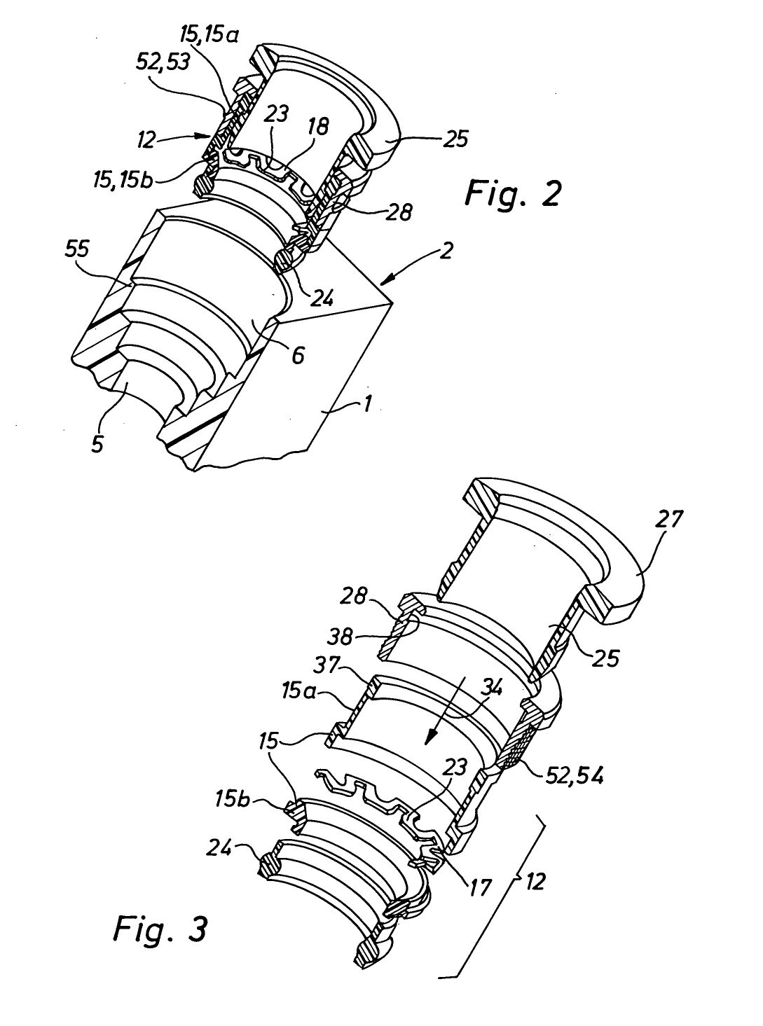

FIG. 2 shows the arrangement of FIG. 1, again in a longitudinal sectional elevation, the union being illustrated in a position outside a housing recess prior to the following fitting operation.

FIG. 3 shows the union of FIGS. 1 and 2, again in a longitudinal section, in an exploded view.

The drawing shows a portion of the housing 1 of a fluid power device generally referenced 2, which is provided with at least one union 3, which renders possible the releasable sealing connection of a fluid line 4 indicated in chained lines.

This fluid power device 1 may for example be a valve serving for the control of a fluid flow or of some drive, able to be operated by a fluid pressure medium, such as a linear drive or a rotary drive.

The housing 1 of the fluid power device 2 gerenally has a plurality of fluid lines in it, of which one will be seen at 5 in FIGS. 1 and 2. The supply and/or venting of a pressure medium, more particularly compressed air, for operation of the fluid power device 2 takes place through this fluid line 5. The terminal section, termed a housing recess 6 of the fluid power line 5 opens at the outer face 7 of the housing 1. The opening of the housing recess 6 is indicated at 8.

A fluid line 4 can be inserted in the housing recess 6 in order to render possible the supply and venting of fluid to and from the fluid line 5 from the outside. In the case of fluid line it is for example a question if pressure medium hose.

The union 3 renders possible a reliable retention of the inserted fluid line 4 while simultaneously providing a sealing action to prevent undesired leakage.

The union 3 comprises a subassembly, which is able to be inserted into the housing recess 6 by a plugging operation and which will be termed an insert 12. The direction 13 of insertion, which is the same direction as the direction as the longitudinal axis 14 of the housing recess 6, is indicated at 13 by an arrow.

The insert 12 comprises a sleeve-like insert body 15, which in the working embodiment is made up of two coaxially following insert body parts 15a and 15b. The insert body parts are firmly and preferably permanently connected together, more especially by a welding operation. The two preferably consist of plastic material.

In the transition zone two insert body parts 15a and 15b an annular groove 16 is defined which is open toward the inner peripheral face of the insert body 15. In the groove 16 arresting means 17 are set, which serve to hold the inserted fluid line 4.

In the case of the arresting means 17 it is preferably a question of a holding ring 18 made of resiliently elastic material and more particularly of spring steel, the outer edge 22 of the ring 18 fitting into the annular groove 16 and accordingly being permanently tethered or retained.

The holding ring 18 has a plurality of arresting projections 23 which are distributed in the peripheral direction and radially extend inwardly. Preferably the arresting projections 23 have a slightly oblique setting and extend obliquely in the direction of insertion toward the free end opposite to the outer edge 22. The arresting projections 23, which are more particularly configured like claws, have resiliently elastic properties and are flexible.

A fluid line 4, which is to be connected, is introduced coaxially into the insert 12 and is plugged through the holding ring 18. Its outer periphery is somewhat larger than the inner periphery delimited by the free ends of the arresting projections 23 so that the arresting projections 23 are deflected and thrust with the resulting restoring force against the outer periphery of the fluid line 4. This means that the fluid power line 4 is secured and can not be pulled out later.

The rear side, facing in the direction 13 of insertion, of the insert body 15 bears a coaxially arranged sealing ring 24. The attachment may for example be by means of a detent connection 25.

The insert 12 is accordingly a subassembly made up of the components put together even prior to assembly in the housing recess 6, that is to say the insert body 15, the arresting means 17 and the sealing ring 14.

In the course of the assembly of the union 3 in the housing recess 6 the insert 12 is inserted in this assembled subassembly. As an alternative it would however also be possible to design the sealing ring 24 in the form of separate components, not belonging to the insert 12. It can then be inserted previously in a separate assembly step in the housing recess 6.

The insert 12 comprises at least the insert body 15 comprising, in the present example, two insert body parts 15a and 15b and the arresting means 17 which are more particularly permanently attached to it.

From the front side, which faces in a direction opposite to the insertion direction 13, an annular release element 25 is moved coaxially into the into the insert body 15. It comes to a halt with an actuating end short of the back, facing toward the front side of the insert body 15, of the arresting projections 23. It is able to be set in relation to the insert body 15 and in a direction opposite to the insertion direction 13. On an actuating portion 27 placed at the front side clear of the insert body 15 it is possible for a release force F_{L} directed in the insertion direction 13 to be applied manually so that the release element may be moved inward and the arresting projections 23 can be so acted on that they are moved clear of the outer periphery of the inserted fluid line 4. A previously inserted fluid line 4 may then be pulled out again without any trouble.

The insert 12 provided with the arresting means 17 can be fixed in the housing recess 6 by press fitting measures to be axially immovable. Such press fitting measures comprise pressing in an attachment ring 28, which is separate from the insert 12, in such a manner that it is press fitted in the housing recess 6 to the front of at least one support face 32, which faces opposite to the direction 13 of insertion of the insert 12, and so prevents the insert 12 being later removed from the housing recess 6.

In the working embodiment the insertion of the insert 12 and the press fitting of the attachment ring 28 take place in a single working step. For this purpose the attachment ring 28, which preferably is sleeve-like in form, is coaxially slipped over the insert body 15 from the front side 33 (facing opposite to the later insertion direction 13) before the insert 12 has been inserted in the housing recess 6. The slipping over operation is indicated in FIG. 3 at 34 by the arrow. In the slipped on state, which is illustrated in FIGS. 1 and 2, the insert body 15 is surrounded in a cuff-like fashion from its front side 33 along a part of the its length by a sleeve-like press fitted section 35 of the attachment ring 28. In this condition the insert 12 and the attachment ring 28 constitute a pre-assembled subassembly.

In order to secure the slipped on attachment ring 28 in the axial direction it is possible, as illustrated, t provide suitable detent means 36. For instance on its front end portion the insert body 15 has in the radially outer part a preferably surrounding detent projection 37, on which a detent recess 38, provided in the inner periphery of the attachment ring 28, may snap, when desired slipped on position is reached.

Preferably an abutment section 42 is provided on the attachment ring 28 in front of the insert body 15. Here it is a question more particularly of a radial projection on the attachment ring 28, such projection extending past the front terminal face of the insert body, such projection being more especially annular in form. The above mentioned front terminal end of the insert body 15 forms, in the present working example, one of the above mentioned support faces 32, with the aid of which the attachment ring 28 may exert an axial holding force on the insert body 15.

The union 3, which has been pre-assembled in this manner, is then inserted bodily through the opening 8 coaxially into the housing recess 6. During such insertion operation the attachment ring 28 is press fitted into the housing recess 6. The press fitting force FE is more particularly applied by the intermediary of the front terminal face, facing in the opposite direction to the insertion direction 13, of the attachment ring 28. To the extent that the release element 25 should be already mounted on press fitting, a suitable pressing tool or pusher may be inserted into the axial intermediate space between the attachment ring 28 and the actuating portion 27 of the release element 2. As an alternative there is also the possibility of only inserting the release element 25 when the press fitting operation is already completed. The release element may more especially be inserted in the insert body 15 with a detent locking effect.

The desired press fit may be ensured, for example, by providing the attachment ring 28 with a slightly larger outer diameter at the sleeve-like press fitting section 35, than the inner diameter of the housing recess 6 in the same portion.

In the fitted state the sealing ring, arranged in the interior of the housing recess 6 to the rear on the insert body 15, makes sealing contact with the wall 43 of the housing recess 6. Furthermore, owing to the sealing ring 24 the fluid power line 4, which is later inserted, is surrounded with a sealing contact at the outer periphery. This means that the transition zone between the housing 1 and the fluid line 4 is securely sealed.

In the preferred working example the insert body 15 has its periphery stepped in the longitudinal direction. Starting at the front side 33 the outer periphery firstly has a receiving section 44, which receives the sleeve-like press fitting section 35 of the slipped on attachment ring 28. Following the receiving section 44 there is a centering section 46 with a step 45 in between. The centering section 46 has a larger outer diameter than the receiving section 44, the radial height of the step being equal to approximately the thickness of the wall of the press fitting section 35.

The press fitted section 35 has its terminal face 47, facing in the insertion direction 13, preferably in contact with the facing terminal face of the step 45 so that the latter may form a further support face 32 for the attachment ring 28. The axial holding forces applied by the attachment ring 28 on the insert body 15 may be thus distributed in an optimum fashion.

The outer diameter of the centering section 46 is preferably slightly smaller than the front length section of the housing recess 6, which extends from the outer face 7 as far as that position, which is assumed by the centering section 46 in the inserted state of the insert body 15. This means that the insert body 15 is not compressed radially on insertion into the housing recess 6 and that it is simultaneously possible to ensure exactly centered insertion into the housing recess 6. The latter is more especially relevant if fitting of the union 3 is so performed that firstly the insert 12 is inserted into the housing recess 6 and is only press fitted in the attachment ring 28 after this.

The attachment ring 28 has its sleeve-like section 35 preferably seated on the insert body 15 without any press fitting effect. Furthermore, the attachment ring 28 is so designed as regards its geometry and material that in the press fitted state it does not apply any radial forces to the insert body 15 in the press fitted condition either. This means that more particularly there is an optimum freedom of movement of the sliding release element 25.

The outer periphery of the press fitted section 35 is preferably such that it is slightly larger than that of the centering section 46.

In order to prevent axial crushing of the insert body 15 on press fitting of the attachment ring 28 the attachment ring 28 preferably bears abutment means 48 to limit the depth of press fitting. In the working embodiment illustrated such means include an abutment collar 48a, placed on the front side of the attachment ring 28 and extending radially outward so that in the state of maximum press fitting depth it engages the edge face of the housing 1 surrounding the opening 8 of the housing recess 6.

For optimum anchoring of the union 3 in the housing recess 6 the attachment ring 28 is provided with projection-like anchoring means 52 on the outwardly facing outer face of the press fitted section 35. The same are provided to engage the wall 43 of the housing recess 6 in the press fitted state of the attachment ring 28 and provide an interlocking anchoring enclosure therewith.

As shown in FIGS. 1 and 2 in the case of anchoring means 52 it is a question of at least one and preferably exactly one radial projection 53, which may possess a tooth-like cross section and which extends over the entire outer periphery of the press fitted section 35. In case of need it is also possible to provide a plurality of radial projections 53 of this type with an axial clearance between them. Such design of the anchoring means 52 is preferred, when the housing 1 generally or at least at the wall 43 of the housing recess 6, consists of plastic material. This material yields more readily in the course of press fitting so that a mere frictional connection is not as a rule sufficient to. provide the desired strength of the joint. The radial projections 53 may now bite into the housing material and accordingly cause an additional interlocking anchoring effect. Since the housing 1 is of plastic there is no danger of the radial projections 53 being shorn off on press fitting the attachment ring 28.

In cases in which the housing 1, or at least the wall 43, consists of relatively hard material and more especially of metal, the utilizeation of the above mentioned radial projections 53 as anchoring means 52 is not to be recommended. They might readily shear off during press fitting. In the case of such applications as anchoring means use is more particularly made of such projection-like humps as have a minimum height but are distributed over a relatively large area of the outer face of the press fitted section 35. Such anchoring means may more particularly be designed more particularly in the form of knurlings 54 as is indicated in FIG. 3. In connection with a metallic housing same ensure optimum anchoring of the press fitted attachment ring 28.

Owing to the design, which is separate as regards the insert body 15, of the attachment ring 28 it is possible without any trouble to simultaneously have a plurality of attachment rings having different configurations of the anchoring means 52 in accordance with the housing material, an insert 12 being combined if expedient with that attachment ring 28 which has the best anchoring means 52 for the particular application. It will be clear in this connection the attachment ring 28 could be selected from more than two different types thereof.

It is noted in connection with the insert body 15 that its depth of fitting is more especially predetermined by at least one step 55 in the housing recess 6. This step 55 is preferably located generally in the vicinity of the arresting means 17.

1. A union for fluid power lines designed for press fitting in a housing recess (6), comprising an insert (12) adapted to be inserted into the housing recess (6), such insert including at least one sleeve-like insert body (15) and arresting means (17), fixed on such insert body (15), serving to hold the fluid line (4) to be attached, such insert being designed to be secured in the housing recess (6) by press fitting, characterized in that for securing the insert (12) placed in the housing recess (6) a separate attachment ring (28) is provided which is in front of at least one support face (32) on the insert (12), said support face facing in a direction opposite to the direction of insertion (13), such ring (28) being adapted for being press fitted in the housing recess (6).

2. The union as set forth in claim 1, characterized in that the attachment ring (28) is sleeve-like in design.

3. The union as set forth in claim 1 or claim 2, characterized in that the attachment ring (28) surrounds the insert body (15) from the front side (33) which is turned in the direction opposite to the direction (13) of insertion in a cuff-like fashion along at least a part of the length thereof.

4. The union as set forth in claim 3, characterized in that the insert body (15) possesses an outer periphery which is stepped in the length direction and has a receiving section (44) of smaller diameter, said receiving section being associated with the front portion facing opposite insertion direction (13), said receiving section (44) being able to be slipped over the attachment ring (28), and furthermore possesses a centering section (46) with a larger diameter and following the receiving section (44) in the direction (13) of insertion, such centering section (46) being provided more especially for centering in the housing recess (6).

5. The union as set forth in claim 4, characterized in that the thickness of the wall of the length section (35), seated on the receiving section (44), of the attachment ring (28) is equal to generally at least the radial height of the step (45) between the receiving section (44) and the centering section (46).

6. The union as set forth in any one of the claims 1 through 5, characterized in that the attachment ring (28) is able to be slipped onto the insert body (15), it being preferably locked on the insert body (15) in the slipped on state.

7. The union as set forth in any one of the claims 1 through 6, characterized in that the attachment ring (28) possesses a section (35) for press fitting, such section being arranged in the fitted state of the union in the housing recess (6), such section (35) possessing anchoring means (52) on the outer periphery thereof in order to engage the wall (43) of the housing recess (6) in an anchoring manner.

8. The union as set forth in claim 7, characterized in that for securing the insert (12) a selection of attachment rings (28) is provided, such rings differing at least as regards the design of the anchoring means (52) of the press fitted section (35).

9. The union as set forth in claim 8, characterized by at least two alternatively usable attachment rings (28), of which the one is designed for anchoring in the recess (6) of a metallic housing and of which the other is designed for anchoring in the recess (6) of a plastic housing.

10. The union as set forth in claim 9, characterized in that the attachment ring (28) provided for anchoring in a metallic housing has knurled (54) anchoring means (52) and the attachment ring (28) provided for anchoring in a plastic housing possesses anchoring means (52) constituted by at least one surrounding radial projection (53).

11. The union as set forth in any one of the claims 1 through 10, characterized in that a face section (32) is constituted by the front terminal face, facing in a direction opposite to the insertion direction (13), of the insert body (15).

12. The union as set forth in any one of the claims 1 through 11, characterized by abutment means (48) on the attachment ring (28) for limiting the depth of press fitting.

13. The union as set forth in any one of the claims 1 through 12, characterized in that the attachment ring (28) has an abutment collar (48a), provided at the edge face, surrounding the opening (8) of the housing recess (6), of the housing (1) provided with the housing recess (6), such edge face surrounding the opening (8) of the housing recess (6).

14. The union as set forth in any one of the claims 1 through 13, characterized in that the arresting means (17) comprise a holding ring (18), which at its outer edge (22) is held on the insert body (15) and which possesses radially inwardly projecting, resiliently elastic, flexible holding projections (23) which are provided for the purpose of acting the outer periphery of its later inserted fluid line (4).

15. The union as set forth in any one of the claims 1 through 14, characterized by a release element (25), of annular configuration, which, from the front side (33) facing opposite to the insertion direction (13), fits coaxially into the insert body (15) and may cooperate with the holding means (17) in order to release an inserted fluid line (4) for the removal of same.

16. The union as set forth in any one of the claims 1 through 15, characterized in that the insert body (15) possesses two insert body parts (15a and 15b) connected together by welding or by some other connecting operation in a firm manner and arranged in axial succession, between which the holding means (17) are held undetachably.

17. The union as set forth in any one of the claims 1 through 16, characterized by a sealing ring (24) fixed on the rear side, facing in the insertion direction (13), of the insert body, such sealing ring (24) being more particularly provided in order to cooperate on the one hand with the outer periphery of an inserted fluid line (4) and on the other hand with the wall (43) of the housing recess (6) in a sealing manner.

18. The union as set forth in any one of the claims 1 through 17, characterized in that the insert (12) and the attachment ring (28) are put together as a subassembly even prior to insertion in a housing recess (6).

19. Fluid power equipment, and more particularly a valve or a drive, comprising at least one housing recess (6) in which a union (3) is anchored, such union being as set forth in any one of the claims 1 through 18.
